(19) United States
(12) Patent Application Publication
(10) Pub. No.: US 2019/0286588 A1
(43) Pub. Date: Sep. 19, 2019

(54) DATA PROCESSING METHOD, DATA PROCESSING DEVICE, AND STORAGE MEDIUM

(71) Applicant: Lenovo (Beijing) Co., Ltd., Beijing (CN)

(72) Inventor: Haitao WANG, Beijing (CN)

(21) Appl. No.: 16/355,689

(22) Filed: Mar. 15, 2019

(30) Foreign Application Priority Data
Mar. 15, 2018 (CN) 201810213557.1
Mar. 15, 2018 (CN) 201810214030.9

(51) Int. Cl. G06F 13/24; G06F 11/30; G06F 11/34

(52) U.S. Cl. CPC G06F 13/24; G06F 11/349; G06F 11/3485; G06F 11/3027

(57) ABSTRACT

The data processing method for a baseboard management controller (BMC) system including two or more chips is provided. The method includes obtaining a first command; determining a first function corresponding to the first command based on the first command; searching for at least one first chip supporting the first function in the two or more chips; and sending the first command to the at least one first chip supporting the first function, such that the at least one first chip executes the first command to implement the first function.

### CROSS-REFERENCES TO RELATED APPLICATIONS

This application claims priority of Chinese Patent Application No. 201810213557.1, filed on Mar. 15, 2018, and Chinese Patent Application No. 201810214030.9, filed on Mar. 15, 2018, the entire contents of all of which are hereby incorporated by reference.

### FIELD OF THE INVENTION

The present disclosure generally relates to the field of data processing technology and, more particularly, relates to a data processing method, a data processing device, and a storage medium.

### BACKGROUND

The baseboard management controller (BMC) refers to a remote management controller of the server. It can perform operations such as firmware upgrades and device view and the like on a device when the device is not in the operational state. However, at present, BMC chip and/or BMC software cause systems to become bigger and bigger, and to have more and more functions. The consequences are bloated systems, slow response, long boot time, and poor customer experience.

The disclosed methods and systems are directed to solve one or more problems set forth above and other problems.

### BRIEF SUMMARY OF THE DISCLOSURE

One aspect of the present disclosure provides a data processing method for a BMC including two or more chips. The method includes obtaining a first command; determining a first function corresponding to the first command based on the first command; searching for at least one first chip supporting the first function in the two or more chips; and sending the first command to the at least one first chip supporting the first function, such that the at least one first chip executes the first command to implements the first function.

Another aspect of the present disclosure provides another data processing method. The data processing method includes monitoring data to be interrupted to obtain monitoring results of the data to be interrupted, determining a first data that meets an interrupt condition in the data to be interrupted according to the monitoring results, sending a data interrupt message for the first data to the BMC, such that a chip supporting the first function of two or more chips included in the BMC acquires a data monitoring result of the first data from the monitoring results of the data to be interrupted after the data interrupt message is received. The first function includes a function of obtaining the data monitoring result of the first data from the monitoring results of the data to be interrupted.

Another aspect of the present disclosure provides a baseboard management controller (BMC) system. The BMC system includes an acquisition unit for obtaining a first command, a determination unit for determining a first function corresponding to the first command based on the first command, a search unit for searching for at least one first chip supporting the first function in two or more chips in the BMC system, and a sending unit for sending the first command to the at least one first chip supporting the first function, such that the at least one first chip executes the first command to implement the first function.

Other aspects of the present disclosure can be understood by those skilled in the art in light of the description, the claims, and the drawings of the present disclosure.

### BRIEF DESCRIPTION OF THE DRAWINGS

FIG. 1 illustrates a flowchart of a data processing method consistent with the disclosed embodiments;

FIG. 2 illustrates a flowchart of another data processing method consistent with the disclosed embodiments;

FIG. 3 illustrates a structural diagram of a BMC system consistent with the disclosed embodiments;

FIG. 4 illustrates a flowchart of another data processing method consistent with the disclosed embodiments;

FIG. 5 illustrates a schematic diagram of a sensor sending an interrupt message to a BMC through a GPIO interface consistent with the disclosed embodiments;

FIGS. 6A-6B illustrate a schematic diagram of a sensor sending an interrupt message to a BMC through a data protocol consistent with the disclosed embodiments;

FIG. 7 illustrates a flowchart of another data processing method consistent with the disclosed embodiments;

FIG. 8 illustrates a first structural diagram of a data processing device consistent with the disclosed embodiments;

FIG. 9 illustrates a second structural diagram of a data processing device consistent with the disclosed embodiments;

FIG. 10 illustrates a third structural diagram of a data processing device consistent with the disclosed embodiments;

FIG. 11 illustrates a fourth structural diagram of a data processing device consistent with the disclosed embodiments;

FIG. 12 illustrates a fifth structural diagram of a data processing device consistent with the disclosed embodiments consistent with the disclosed embodiments;

FIG. 13 illustrates a sixth structural diagram of a data processing device consistent with the disclosed embodiments consistent with the disclosed embodiments; and

FIG. 14 illustrates a seventh structural diagram of a data processing device consistent with the disclosed embodiments.

### DETAILED DESCRIPTION

In order to understand the features and technical contents of the present disclosure in more detail, the implementation of the present disclosure will be described in detail below with reference to the accompanying drawings. The accompanying drawings are for illustrative purposes only and are not intended to limit the disclosure.

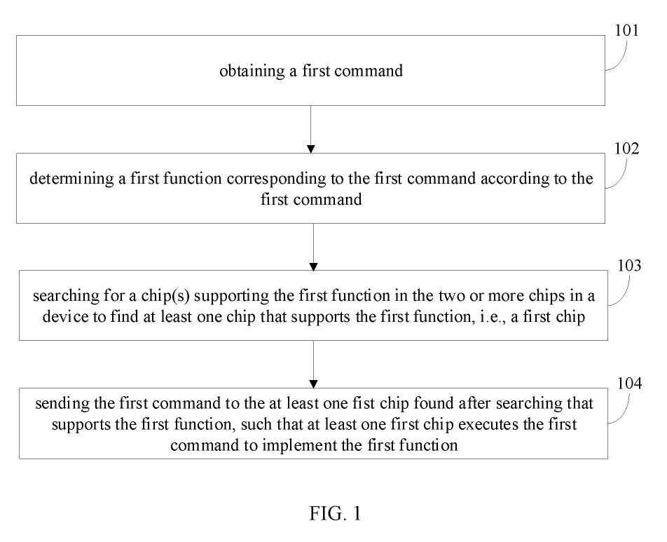

FIG. 1 illustrates a flowchart of a data processing method consistent with the disclosed embodiments. As shown in FIG. 1, the method includes the following steps:

S101: obtaining a first command.

In one embodiment, obtaining the first command may include generating the first command after a first operation is detected.

In one embodiment, obtaining the first command may include receiving a data interrupt message sent by a data monitoring unit. The data interrupt message is a data interrupt message of a first data that meets the interrupt condition in the data to be interrupted monitored by the data monitoring unit. The first command includes the data interrupt message.

S102: determining a first function corresponding to the first command according to the first command.

S103: searching for a chip(s) supporting the first function in the two or more chips in a device to find at least one chip that supports the first function, i.e., a first chip.

S104: sending the first command to the at least one first chip found after searching that supports the first function, such that at least one first chip executes the first command to implement the first function.

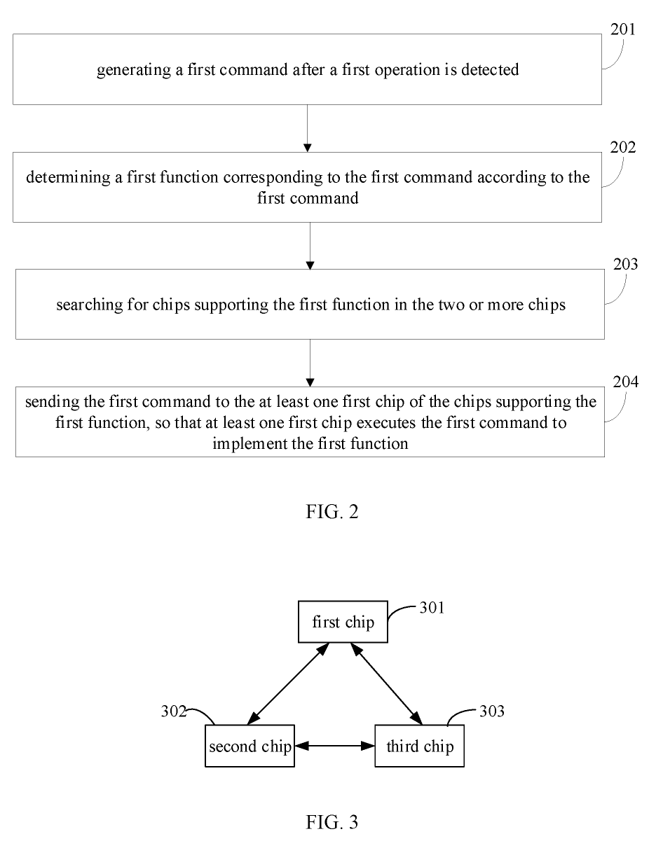

The following describes two implementation manners of S101 respectively. FIG. 2 illustrates a flowchart of another data processing method consistent with the disclosed embodiments. As shown in FIG. 2, the method includes the followings.

S201: generating a first command after a first operation is detected.

In one embodiment, the first operation may be an operation generated by a user touching a physical button of a device. For example, the physical button is a power button on the device, and after the user triggers the power button, the device can detect a power-on operation generated by the user touching the power button, and then generate a power-on command according to the detected power-on operation.

On the other hand, the first operation may be an operation generated by a user touching a function module in an app installed on the device. For example, the app may be an app with an information search function installed on the device. After the user searches for information through the app, the information to be searched is input into the information input box of the app. By clicking the information search icon of the app, the app searches for information. The information search module in the app can detect the information search operation generated by the user touching the information search icon, and generate the information search command according to the detected information search operation.

The device may specifically be a device with an installed BMC system. For example, the device may be a terminal such as a desktop computer, a laptop, a PAD and the like.

S202: determining a first function corresponding to the first command according to the first command.

In one embodiment, after the device generates the first command according to the detected first operation, the first command is parsed to obtain the first function corresponding to the first command. For example, when the first command is a power-on command, by parsing the power-on command, the function corresponding to the power-on command is determined to be a power-on function. When the first command is an information search command, by parsing the information search command, the function corresponding to the information search command is determined to be a network search function.

S203: searching for chips supporting the first function in the two or more chips.

In one embodiment, the BMC system in the device has two or more chips divided according to different functions. After the device determines the first function corresponding to the first command according to the first command, the chip set in the BMC system needs to be searched for chips supporting the first function.

The chip set includes at least two chips, and the at least two chips support different functions. For example, one chip supports the internet access function and the other chip supports the video playback function.

Specifically, two chips with different functions are interconnected by a communication interface to form a complete BMC system. For example, when the device generates a video playback command according to the user's operation, it is necessary to search for a chip with the video playback function in the chip set.

The communication interface between the two chips with different functions may be a serial port or a parallel port. The type of the specific communication interface is not limited, as long as the connection between two different chips can be realized. Each chip does not have to use a complex Linux operating system, some real-time operating systems, such as uc/cos, FreeRTOS, RT-thread, and the like can be used.

S204: sending the first command to the at least one first chip supporting the first function, so that the at least one first chip executes the first command to implement the first function.

In one embodiment, a firmware (FW) is stored in each chip. The FW refers to the “driver” internally stored in chips. Through the firmware, according to the standard device driver, the operating system in the device can implement specific operations of the device. For example, the optical drive, the recorder, and the like all have the internal firmware.

After the device finds the chips with the first function in the chip set, the first command triggered by the user is only sent to chips supporting the first function. After chips supporting the first function receive the first command, the first command is executed to implement the first function. The other chips except chips with the first function in the chip set do not execute the first command. In this way, each chip in the chip set can clearly know the functions supported by each chip, and avoid the situation that the BMC system is unstable due to too many loadings of the chips, thereby speeding up the boot time of the BMC and improving the user experience.

In one embodiment, after the device determines that the first function is implemented on the premise that the second function is implemented first, the device searches for chips supporting the second function in the two or more chips, i.e., second chips. The device send a second command corresponding to the second function to at least one second chip in chips supporting the second function, so that at least one second chip executes the second command to implement the second function.

For example, the first function is the video playing function. Through the video resource searched by a user, after the device determines to implement the video playing function, the device must be connected to the network. Thus, it is determined that the first function is implemented on the premise that the second function is implemented first. That is, it is determined that the network connection function needs to be implemented first before the device implements the video playback function.

In one embodiment, the device further controls two or more chips in the BMC system to send a heartbeat message to each other within a preset period. When at least one of the two or more chips does not receive the heartbeat message within the preset period, the BMC is determined to be faulty. The details are shown in FIG. 3.

FIG. 3 illustrates a structural diagram of a BMC system consistent with the disclosed embodiments. As shown in FIG. 3, the BMC system includes three chips, and the three chips are divided according to functions. The first chip 301 focuses on processing network and web. The first chip 301 can be represented by function network/web. The second chip 302 focuses on processing video, LPC, mouse and keyboard, and the like. The second chip 302 can be represented by function KVM/KCS. The third chip 303 focuses on sensor and log record. The third chip 303 can be represented by function sensor monitor/log.

Specifically, after the device sends a heartbeat message between the three chips (chip 301, chip 302, and chip 303) according to a preset period such as 5 seconds. If the chip 301 (network/web) does not receive the heartbeat message sent by the chip 303 in the preset period of 5 seconds, the BMC system is determined to be faulty. In this way, by mutual monitoring between the chips, the BMC system crash can be avoided.

In one embodiment, after the device detects a second operation, a third command is generated. After the third command is determined to be a program update command for chips, the third command is parsed to obtain the program version information carried in the third command. According to the program version information, chips to be updated are determined in the two or more chips. The third command is sent to chips to be updated, so that chips to be updated execute the third command to complete the program update operation.

The program version information includes the program version model, the chip model, and the like. Specifically, after the device obtains the program update command, the chip model carried in the program update command may be compared with each chip model in the BMC system, and obtain the comparison result. After the comparison result indicates that chips with the same chip model in the program update command are found in the BMC system, the found chips are determined to be chips to be updated.

In one embodiment, the device sends the third command to chips to be updated, so that after chips to be updated execute the third command to complete the program update operation, the device further determines the operational states of other chips except chips to be updated in the two or more chips. After other chips are determined to be in the execution task state according to the operational states of the other chips, the other chips are controlled to maintain the current operational state. Thus, even during the FW update of each chip, other Chips in the chip set can continue to work and provide external services.

It can be understood that the BMC refers to a remote management controller of a server. The BMC can perform firmware upgrades and device view and the like operations on the device when the device is not turned on. However, at present, after the current BMC obtains the sensor data of the device, usually by sending a poll request to each device sensor continuously, the current BMC obtains the monitoring result of the device senor data.

The active poll sensor solution of the BMC increases the BMC loadings, and is not conducive to the BMC's rapid and timely response. The following method is used to solve the above problems.

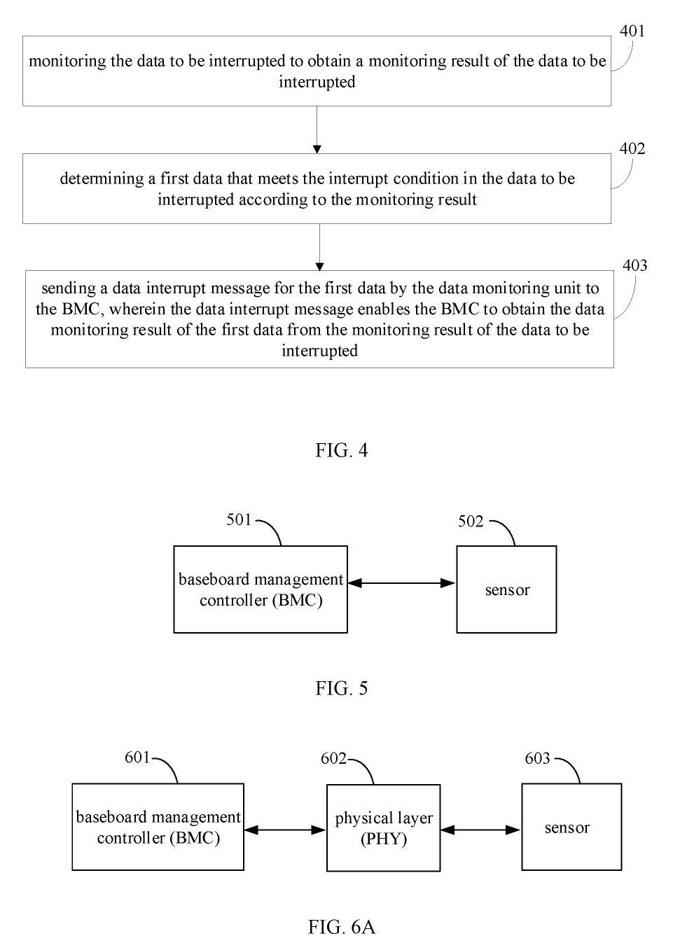

FIG. 4 illustrates a flowchart of another data processing method consistent with the disclosed embodiments. As shown in FIG. 4, the method includes the followings.

S401: monitoring the data to be interrupted to obtain a monitoring result of the data to be interrupted.

In one embodiment, the method is mainly applied to an electronic device, and the electronic device may be a computer, a notebook computer, a terminal server, a tablet computer, or the like. A BMC system is installed in the electronic device. According to state information of each component to be monitored reported by a sensor, the BMC system acquires the senor data of each component to be monitored.

Specifically, the electronic device may monitor the data to be interrupted by a sensor to obtain the monitoring result of each data in the data to be interrupted. The data to be interrupted includes data of more than one component to be monitored, such as fan speed value data, CPU temperature value data and the like. After the sensor monitors the CPU temperature of the device, the monitoring result obtained can be the CPU temperature value.

S402: determining a first data that meets the interrupt condition in the data to be interrupted according to the monitoring result.

In one embodiment, since the sensor monitors the data of more than one component to be monitored in the device, the obtained monitoring result of the data to be interrupted is also the monitoring data of more than one component to be monitored.

Specifically, after the sensor determines, according to the monitoring result of the data to be interrupted, that the monitoring data of at least one monitoring component in the data to be interrupted meets the interrupt condition, the monitoring data of each monitoring component in the monitoring result of the data to be interrupted may be compared with the corresponding preset parameters in the interrupt condition, and the comparison result is obtained. According to the comparison result, it is determined that the first data that meets the interrupt condition in the monitoring result of the data to be interrupted.

The interrupt condition may be that at least one of a time interval parameter and/or the data change rate parameter and/or at least one processing threshold parameter that satisfies the condition.

For example, when the interrupt condition is the time interval parameter, and the monitoring data in the monitoring result is greater than the preset parameter, the monitoring data in the monitoring result of the data to be interrupted is determined to meet the interrupt condition. Accordingly, each monitoring data of the monitoring result of the data to be interrupted is compared with the preset data in the interrupt condition, the monitoring data larger than the preset parameter is determined as the first data satisfying the interrupt condition.

For another example, when the interrupt condition is the time interval parameter, and the monitoring data in the monitoring result is in the preset parameter range, the monitoring data in the monitoring result of the data to be interrupted is determined to meet the interrupt condition. Accordingly, each monitoring results of the data to be interrupted is compared with the preset parameter in the interrupt condition, the monitoring data in which the data parameter is in the preset parameter range is determined as the first data satisfying the interrupt condition.

S403, sending a data interrupt message for the first data by the data monitoring unit to the BMC, wherein the data interrupt message enables the BMC to obtain the data monitoring result of the first data from the monitoring result of the data to be interrupted.

In one embodiment, after the sensor determines that the monitoring data of at least one monitoring component in the data to be interrupted meets the interrupt condition according to the monitoring result of the data to be interrupted, the interrupt message for the monitoring component that meets the interrupt condition is sent to the BMC.

Specifically, after the sensor determines that the monitoring data of at least one monitoring component in the data to be interrupted meets the interrupt condition according to the monitoring result of the data to be interrupted, the sensor may send a data interrupt message for the first data to the BMC through a General Purpose Input/Output (GPIO) interface, so that the BMC obtains the data monitoring result of the first data from the monitoring result of the data to be interrupted according to the data interrupt message. A schematic diagram of sending an interrupt message to the BMC through the GPIO interface is shown in FIG. 5

FIG. 5 illustrates a schematic diagram of a sensor sending an interrupt message to a baseboard management controller (BMC) through a GPIO interface consistent with the disclosed embodiments. As shown in FIG. 5, the system includes a BMC 501 and a sensor 502. Specifically, after the sensor 502 detects that the first data in the data to be interrupted meets the interrupt condition, the sensor 502 sends the GPIO interrupt message for the first data to the BMC 501. After the BMC 501 receives the GPIO interrupt message, the data interrupt message is parsed to obtain the parsed data for the data interrupt message, and the data monitoring result of the first data is extracted from the parsed data. When the BMC 501 extracts the data monitoring result of the first data in the parsed data, it means that the data interrupt message for the first data sent by the sensor 502 to the BMC 501 carries the data monitoring result of the first data. The data interrupt message enables the BMC 501 to obtain the data monitoring result of the first data from the data interrupt message.

When the BMC 501 does not extract the data monitoring result of the first data in the parsed data, it means the data interrupt message for the first data sent by the sensor 502 to the BMC 501 does not carry the data monitoring result of the first data. The BMC 501 sends a data acquisition request for the data monitoring result of the first data to the sensor 502. After the sensor 502 receives the data acquisition sent by the BMC 501, the data monitoring result of the first data is extracted from the monitoring result of the data to be interrupted, and the extracted data monitoring result of the first data is sent to the BMC 501. At this time, the BMC 501 determines that the data acquisition request is successfully responded by the sensor 502, and receives the data monitoring result of the first data sent by the sensor 502. The BMC 501 obtains the data monitoring result of the first data, that is, the sensor data of the first data. By actively sending sensor data to the BMC, the sensor not only enables the BMC to reduce unnecessary threads and loadings, but also enhances the robustness and stability of the BMC programs.

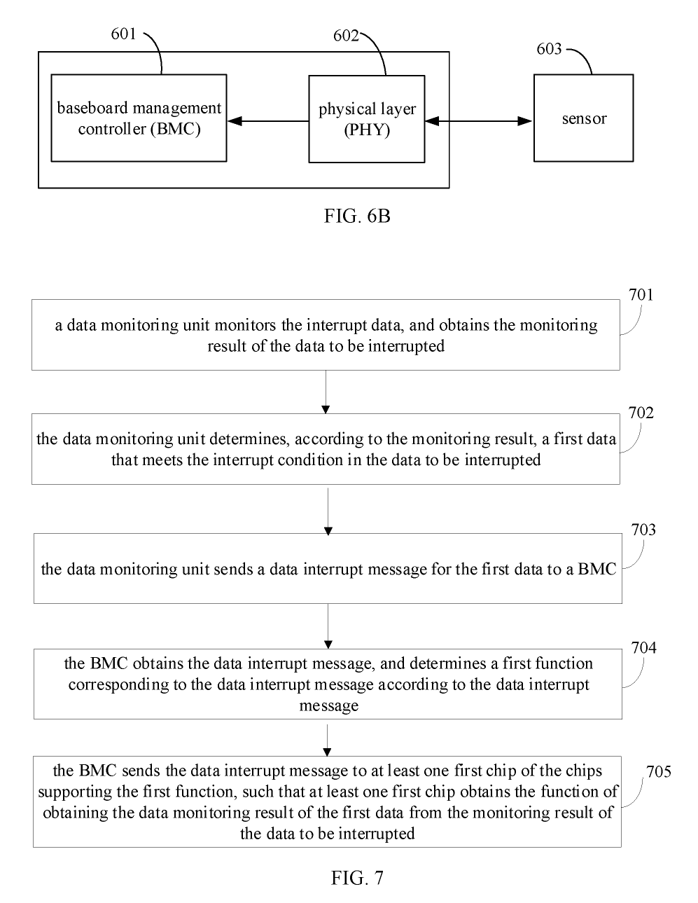

In one embodiment, according to the monitoring result of the data to be interrupted, after the sensor determines that the monitoring data of the at least one monitoring component in the data to be interrupted meets the interrupt condition, by sending a data interrupt message for the first data to the BMC through a data protocol, according to the interrupt message, the BMC obtains the data monitoring result of the first data from the monitoring result of the data to be interrupted. A schematic diagram of sending an interrupt message to the BMC through the data protocol is shown in FIGS. 6A-6B.

FIG. 6A and FIG. 6B illustrates a schematic diagram of a sensor sending an interrupt message to a BMC through a data protocol consistent with the disclosed embodiments. As shown in FIG. 6A and FIG. 6B, the BMC system includes a BMC 601, a physical layer (PHY) 602 and a sensor (Sensor) 603. The physical layer 602 in FIG. 6A exists independently, and the physical layer in FIG. 6B is integrated into the BMC 601.

Specifically, after the sensor 602 detects that the first data in the data to be interrupted meets the interrupt condition, through the data protocol the interrupt message for the first data is sent to the physical layer 602. After the physical layer 602 receives the data protocol interrupt message, the data protocol interrupt message is sent to the BMC 601. After receiving the data protocol interrupt message, the BMC 601 parses the data protocol interrupt message to obtain the parsed data for the data protocol interrupt message.

After it is determined, according to the parsed data, that the data protocol interrupt message carries the data monitoring result of the first data, the BMC 601 directly extracts the data monitoring result of the first data in the parsed data. After it is determined, according to the parsed data, that the data protocol interrupt message does not carry the data monitoring result of the first data, the BMC 601 further sends a data acquisition request for the first data to the sensor 603 through the physical layer 602 to obtain the data monitoring result of the first data.

After the sensor 603 receives the data acquisition request, the data monitoring result of the first data is extracted from the monitoring result of the data to be interrupted. The data monitoring result is sent to the BMC 601 through the physical layer 602. At this time, the BMC 601 obtains the data monitoring result of the first data, that is, the sensor data of the first data. In this way, by reporting the sensor data to the BMC, the sensor enables the BMC not only to reduce the unnecessary threads and loadings, but also to reduce the BMC boot time, and increase the customer experience. The sensor also enhances the robustness and stability of the BMC programs, and facilitates rapid collection of sensor data and quick response to events. The interrupt methods issued by the sensor are not limited to the GPIO interrupt and the data protocol interrupt.

FIG. 7 illustrates a flowchart of another data processing method consistent with the disclosed embodiments. As shown in FIG. 7, the method includes the followings.

S701: a data monitoring unit monitors the interrupt data, and obtains the monitoring result of the data to be interrupted.

S702: the data monitoring unit determines, according to the monitoring result, a first data that meets the interrupt condition in the data to be interrupted.

S703: the data monitoring unit sends a data interrupt message for the first data to a BMC.

S704: the BMC obtains the data interrupt message, and determines a first function corresponding to the data interrupt message according to the data interrupt message.

In one embodiment, the first command described in FIG. 1 includes a data interrupt message.

In one embodiment, the first function is a function of indicating the BMC to obtain the data monitoring result of the first data from the monitoring result of the data to be interrupted.

S705: the BMC sends the data interrupt message to at least one first chip of the chips supporting the first function, such that at least one first chip obtains the function of obtaining the data monitoring result of the first data from the monitoring result of the data to be interrupted.

In one embodiment, the function of at least one first chip obtaining the data monitoring result of the first data from the monitoring result of data to be interrupted comprises: at least one first chip parsing the data interrupt message, obtaining the parsed data for the data interrupt message, extracting the data monitoring result of the first data in the parsed data; or the at least one first chip sending a data acquisition request for the first data to the data monitoring unit; receiving the data monitoring result of the first data sent by the monitoring unit after the data acquisition request is determined to be successfully responded by the data monitoring unit.

FIG. 8 illustrates the first structural diagram of a data processing device consistent with the disclosed embodiments. As shown in FIG. 8, the device includes an acquisition unit 801, a determination unit 802, a search unit 803, and a sending unit 804.

The acquisition unit 801 is provided for obtaining a first command. The determination unit 802 is provided for determining, according to the first command, a first function corresponding to the first command. The search unit 803 is provided for searching for chips supporting the first function in the two or more chips. The sending unit 804 is provided for sending the first command to the at least one first chip of the discovered chips that supports the first function to enable at least one first chip to execute the first command to implement the first function.

In one embodiment, the device may be a desktop computer, a notebook computer, a PAD. A BMC system is installed in the device, and the BMC system includes two or more chips divided according to functions.

In one embodiment, the determination unit 802 determines that the first function is implemented on the premise that the second function is implemented first, and the search unit 803 is triggered to search for chips supporting the second function in the two or more chips. After the search unit 803 finds chips supporting the second function, the search unit 803 sends a second command to at least one second chip of the found chips supporting the second function, so that at least one second chip executes the second command to implement the second function.

In one embodiment, the device further includes a control unit 805. The control unit 805 controls the two or more chips to send a heartbeat message to each other in a preset period to obtain a data reception result for the heartbeat message.

The determination unit 802 further determines, according to the data reception result of the heartbeat message, that the BMC is faulty after at least one of the two or more chips does not receive the heartbeat message in the preset period.

In one embodiment, the device further includes a parsing unit 806. The acquisition unit 801 further generates a third command after a second operation is detected. The parsing unit 806 parses the third command to obtain program version information carried in the third command after the third command is a program update command for chips.

The determination unit 802 determines chips to be updated in the two or more chips according to the program version information. The sending unit 804 sends the third command to chips to be updated, so that chips to be updated execute the third command to complete the program update operation.

In one embodiment, the sending unit 804 sends the third command to chips to be updated, such that after chips to be updated executes the third command to complete the program update operation, the determination unit 802 is triggered to determine the operational state of the other chips except chips to be updated in the two or more chips. After the determination unit 802 determines that other chips except chips to be updated in the two or more chips are in the task execution state, the determination unit 802 triggers the control unit 805 to control the other chips to maintain the current operational state.

It should be noted that, when performing data processing, the data processing devices provided in the above embodiment are only illustrated by the division of each of the above program modules. In practical applications, the processing allocation may be completed by different program modules as needed. The internal structure of the data processing device is divided into different program modules to perform all or part of the processing described above. In addition, both the data processing devices and the data processing methods provided by the above embodiments belong to the same concept. The specific implementation process is described in the methods, and details are not described herein again.

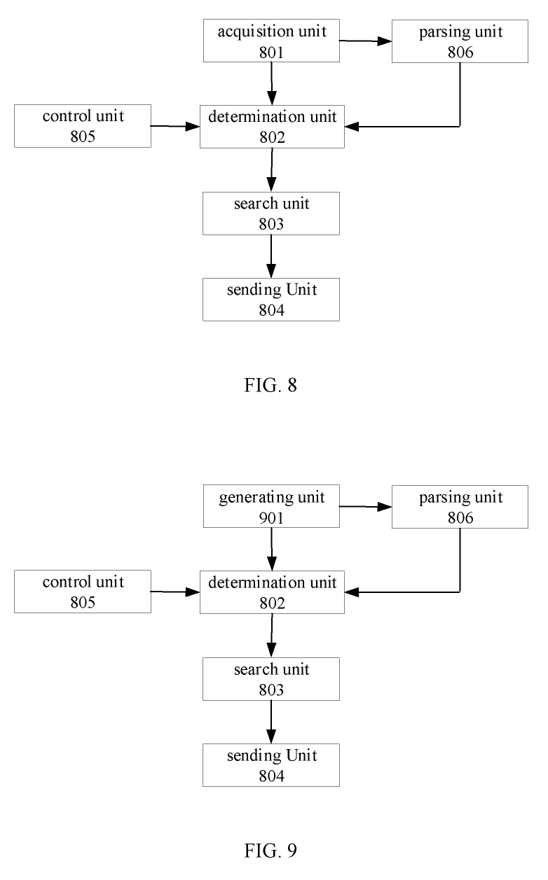

FIG. 9 illustrates the second structural diagram of a data processing device consistent with the disclosed embodiments. As shown in FIG. 9, the device includes a generating unit 901, a determination unit 802, a search unit 803, and a sending unit 804.

The generating unit 901 generates a first command after a first operation is detected. The acquisition unit 801 includes a generating unit 901.

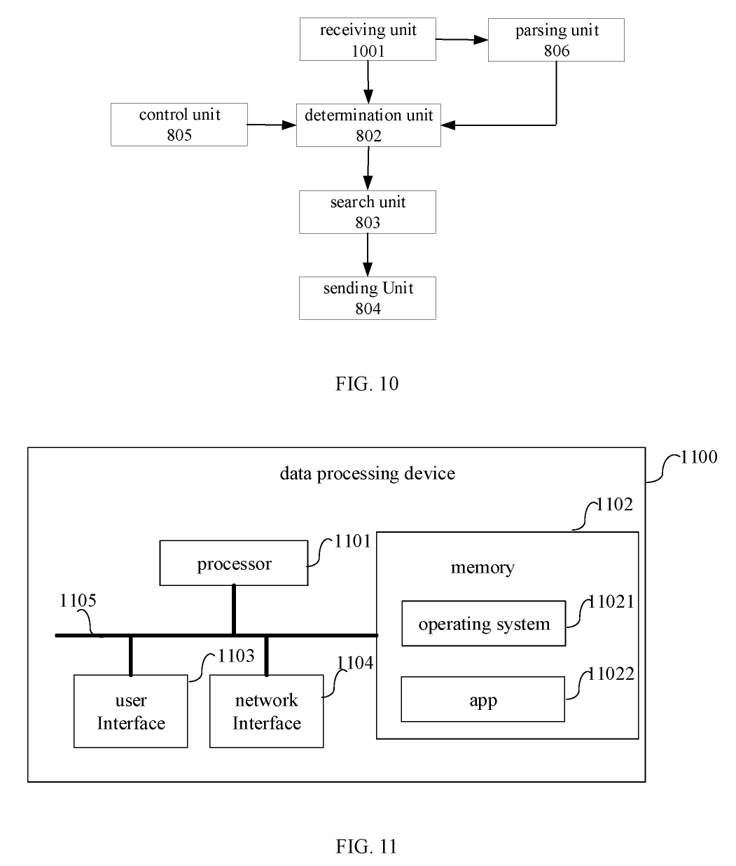

FIG. 10 illustrates the third structural diagram of a data processing device consistent with the disclosed embodiments. As shown in FIG. 10, the device includes: a receiving unit 1001, a determination unit 802, a search unit 803, and a sending unit 804.

The acquisition unit 801 may include a receiving unit 1001 to receive a data interrupt message sent by a data monitoring unit. The data interrupt message is a data interrupt message of the first data that meets the interrupt condition in the data to be interrupted monitored by the data monitoring unit. The first command includes the data interrupt message.

The determination unit 802 may determines a function corresponding to the data interrupt message. The function indicates the BMC to obtain the data monitoring result of the first data from the monitoring result of the data to be interrupted.

The search unit 803 may send the first command to at least one of the found first chips supporting the first function, so that at least one first chip parses the data interrupt message, and obtain the parsed data for the data interrupt message, and the data monitoring result of the first data is extracted from the parsed data. Or the search unit 803 sends the first command to at least one of the found chips supporting the first function, so that the at least one first chip sends a data acquisition request for the first data to the data monitoring unit. After the data acquisition request is determined to be successfully responded by the data monitoring unit, the search unit 803 receives the data monitoring result of the first data sent by the monitoring unit.

FIG. 11 illustrates the fourth structural diagram of a data processing device consistent with the disclosed embodiments. As shown in FIG. 11, the data processing device 1100 may be a mobile phone, a computer, a digital broadcast terminal, an information transceiver device, a game console, a tablet device, a personal digital assistant, an information push server, a content server, an identity authentication server and the like. The data processing device 1100 shown in FIG. 11 includes at least one processor 1101, a memory 1102, at least one network interface 1104, and a user interface 1103. The various components in the data processing device 1100 are coupled together by a bus system 1105. The bus system 1105 implements the connection communication between these components. In addition to the data bus, the bus system 1105 further includes a power bus, a control bus, and a status signal bus. However, for the sake of clarity, various buses are labeled as the bus system 1105 in FIG. 11.

The user interface 1103 may include a display, a keyboard, a mouse, a trackball, a click wheel, a button, a button, a touch panel, a touch screen or the like.

The memory 1102 can be either a volatile memory or a nonvolatile memory, and can include both a volatile memory and a nonvolatile memory. The non-volatile memory may be a Read Only Memory (ROM), a Programmable Read-Only Memory (PROM), or an Erasable Programmable Read-Only Memory (EPROM), an Electrically Erasable Programmable Read-Only Memory (EEPROM), a Ferromagnetic Random-Access Memory (FRAM), a Flash Memory, an Magnetic Surface Memory, a CD-ROM, or a CD-ROM (Compact Disc Read-Only Memory). The magnetic surface memory can be a disk storage or a tape storage. The volatile memory can be a random-access memory (RAM) that acts as an external cache. By the illustrative not limiting description, many forms of RAM are available, such as Static Random-Access Memory (SRAM), Synchronous Static Random-Access Memory (SSRAM), Dynamic Random-Access Memory (DRAM), Synchronous Dynamic Random-Access Memory (SDRAM), Double Data Rate Synchronous Dynamic Random-Access Memory (DDRSDRAM), Enhanced Synchronous Dynamic Random-Access Memory (ESDRAM), SyncLink Dynamic Random-Access Memory (SLDRAM), and Direct Rambus Random Access Memory (DRRAM). The memory 1102 described in one embodiment is intended to include, but not limited to these and any other suitable types of memories.

In one embodiment, the memory 1102 stores various types of data to support the operations of the data processing device 1100. Examples of such data include any computer program for operations on data processing device 1100, such as an operating system 11021 and an app 11022. The operating system 11021 includes various system programs, such as a framework layer, a core library layer, a driver layer and the like for implementing various basic services and handling hardware-based tasks. The app 11022 can include various apps, such as Media Players, Browsers and the like for implementing various app services. The program implementing the method of one embodiment may be included in the app 11022.

The method disclosed in the foregoing embodiments may be applied to the processor 1101 or implemented by the processor 1101. The processor 1101 may be an integrated circuit chip with signal processing capabilities. In the implementation process, each step of the foregoing method may be completed by an integrated logic circuit of hardware in the processor 1101 or a command in the form of software. The processor 1101 described above may be a general-purpose processor, a digital signal processor (DSP), or another programmable logic device, a discrete gate or transistor logic device, a discrete hardware component, or the like. The processor 1101 can implement or perform various methods, steps, and logic blocks disclosed in one embodiment. The general-purpose processor can be a microprocessor or any conventional processor or the like. The steps of the methods disclosed in one embodiment may be directly implemented by a hardware decoding processor, or may be implemented by a combination of hardware and software modules in the decoding processor. The software module can be located in a storage medium. The storage medium is located in the memory 1102. The processor 1101 reads the information in the memory 1102, and completes the steps of the foregoing method in combination with the hardware thereof.

In one exemplary embodiment, the data processing device 1100 may be implemented by one or more Application Specific Integrated Circuits (ASICs), DSPs, Programmable Logic Devices (PLDs), Complex Programmable Logic Devices (CPLDs), Field-Programmable Gate Arrays (FPGAs), general-purpose processors, controllers, Micro Controller Units (MCUs), microprocessor, or other electronic components to perform the foregoing methods.

Specifically, when running computer programs, the processor 1101 executes: obtaining a first command; determining a first function corresponding to the first command according to the first command; searching for chips supporting the first function in more than two chips in the BMC; and sending the first command to at least one of the chips supporting the first function, so that at least one first chip executes the first command to implement the first function.

When running computer programs, the processor 1101 further performs: determining that the first function is implemented on the premise that the second function is implemented first, and searching for chips supporting the second function in the two or more chips; sending a second function to at least one of the found second chips supporting the second function, so that at least one second chip executes the second command and implement the second function.

When running computer programs, the processor 1101 further performs: controlling two or more chips to send a heartbeat message to each other within a preset period; and determining that the BMC is faulty when at least one of the two or more chips does not receive the heartbeat message within the preset period.

When running computer programs, the processor 1101 further performs: generating a third command when a second operation is detected; parsing the third command to obtain the program version information carried in the third command when the third command is determined to be a program update command for chips; determining chips to be updated in two or more chips according to the program version information; and sending the third command to chips to be updated, so that chips to be updated execute the third command to complete the program update operation.

When running computer programs, the processor 1101 further performs: determining that other chips except chips to be updated in the two or more chips are in the task execution state, and controlling other chips to maintain the current operational state.

When executing the acquisition of the first command, the processor 1101 specifically performs: generating a first command after a first operation is detected.

When executing the acquisition of the first command, the processor 1101 specifically performs: receiving a data interrupt message sent by the data monitoring unit, wherein the data interrupt message is a data interrupt message of the first data that meets the interrupt condition in the data to be interrupted monitored by the data monitoring unit, and the first command includes the data interrupt message.

Accordingly, when determining the first function corresponding to the first command according to the first command, the processor 1101 specifically performs: determining a function corresponding to the data interrupt message, wherein the function indicates the BMC to obtain the data monitoring result of the first data from the monitoring result of the data to be interrupted.

One exemplary embodiment provides a computer readable storage medium, such as the memory 1102 including computer programs. The computer programs can be executed by the processor 1101 of the data processing device 1100 to perform the steps in the foregoing method. The computer readable storage medium may be a memory such as FRAM, ROM, PROM, EPROM, EEPROM, Flash Memory, magnetic surface memory, optical disk, or CD-ROM. The medium may also be various devices including one or any combination of the above memories, such as mobile phones, computers, tablet devices, personal digital assistants, and the like.

A computer readable storage medium stores computer programs. When running computer programs, the processor performs: obtaining a first command; determining a first function corresponding to the first command according to the first command; searching for chips supporting the first function in more than two chips in the BMC; and sending the first command to at least one of the found first chips that support the first function, so that at least one first chip executes the first command to implement the first function.

When running computer programs, the processor further performs: determining that the first function is implemented on the premise that the second function is implemented first, and searching for chips supporting the second function in the two or more chips; and sending a second command to at least one of the found second chips that support the second function, so that at least one second chip executes the second command to implement the second function.

When running computer programs, the processor further performs: controlling the two or more chips to send a heartbeat message to each other within a preset period; and determining that the BMC is faulty after at least one of the two or more chips does not receive the heartbeat message within the preset period.

When running computer programs, the processor further performs: generating a third command after a second operation is detected; parsing the third command to obtain the program version information carried in the third command after the third command is determined to be a program update command for chips; determining chips to be updated in two or more chips according to the program version information; and sending the third command to chips to be updated, so that chips to be updated execute the third command to complete the program update operation.

When running computer programs, the processor further performs: determining that other chips except chips to be updated in the two or more chips are in the task execution state, and controlling other chips to maintain the current operational state.

When executing the acquisition of a first command, the processor 1101 specifically performs: generating a first command after a first operation is detected.

When executing the acquisition of a first command, the processor 1101 specifically performs: receiving a data interrupt message sent by a data monitoring unit, wherein the data interrupt message is a data interrupt message of the first data that meets the interrupt condition in the data to be interrupted monitored by the data monitoring unit, and the first command includes the data interrupt message.

Accordingly, when determining the first function corresponding to the first command according to the first command, the processor 1101 specifically performs: determining a function corresponding to the data interrupt message, wherein the function indicates the BMC to obtain the data monitoring result of the first data from the monitoring result of the data to be interrupted.

A data processing device is further provided in one embodiment. The device may be a BMC device which includes two or more chips divided according to functions. After chips supporting the first function receive the first command, the first command is executed to implement the first function. For details, refer to the description of FIG. 3 in the foregoing method embodiments.

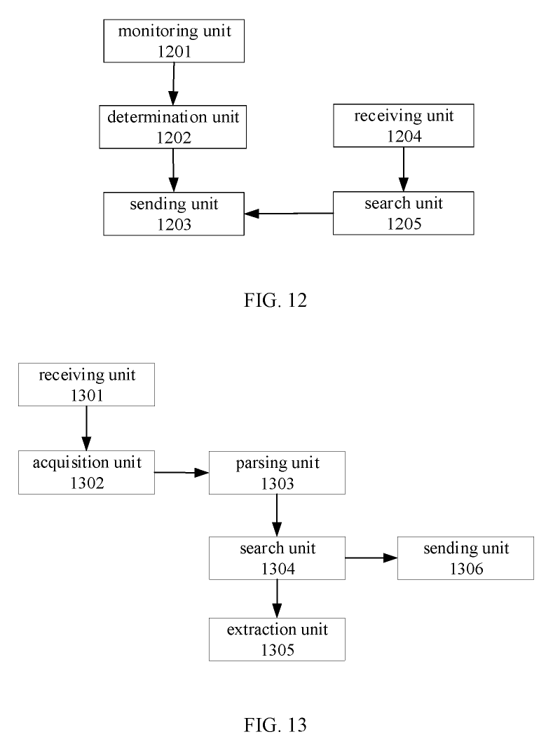

FIG. 12 illustrates the fifth structural diagram of a data processing device consistent with the disclosed embodiments consistent with the disclosed embodiments. As shown in FIG. 12, the device includes: a monitoring unit 1201, a determination unit 1202, and a sending unit 1203.

The monitoring unit 1201 monitors the data to be interrupted, and obtain the monitoring result of the data to be interrupted. The determination unit 1202 determines, according to the monitoring result, the first data that meets the interrupt condition in the data to be interrupted. The sending unit 1203 send a data interrupt message for the first data to the BMC. The data interrupt message enables the BMC to obtain the data monitoring results of the first data from the monitoring result of the data to be interrupted.

In one embodiment, the sending unit 1203 may further send a data interrupt message for the first data to the BMC, so that chips supporting the first function in the two or more chips included in the BMC, after the data interrupt message is received, obtain the data monitoring result of the first data from the monitoring result of the data to be interrupted.

The first function includes a function of obtaining the data monitoring result of the first data from the monitoring result of the data to be interrupted. In one embodiment, the device may be a sensor with data monitoring function.

In one embodiment, the data interrupt message enables the BMC to obtain the data monitoring result of the first data from the monitoring result of the data to be interrupted. The sending unit 1203 sends a data interrupt message for the first data to the BMC. The data interrupt message carries a data monitoring result for the first data. The data interrupt message enables the BMC to obtain the data monitoring result of the first data from the data interrupt message.

In one embodiment, the device further includes: a receiving unit 1204 and a search unit 1205. The data interrupt message enables the BMC to obtain the data monitoring result of the first data from the monitoring result of the data to be interrupted. The data interrupt message may further be: the receiving unit 1204 receiving a data acquisition request sent by the BMC for the first data; triggering the search unit 1205 to search for the data monitoring result of the first data in the monitoring result of the data to be interrupted according to the obtained acquisition request after the receiving unit 1204 receives a data acquisition request sent by the BMC for the first data; triggering the sending unit 1203 to send the found data monitoring result of the first data to the BMC after the search unit 1205 finds the data monitoring result of the first data in the monitoring result of the data to be interrupted.

It should be noted that, when the data processing devices provided by the foregoing embodiment sends the sensor data to the BMC, only the division of each of the foregoing program modules is illustrated. In practical applications, the foregoing processing may be allocated by different program modules as needed. That is, the internal structure of the data processing device is divided into different program modules to perform all or part of the processing described above. In addition, both the data processing devices provided by the foregoing embodiment and the foregoing data processing method embodiments belong to the same concept, and the specific implementation process is described in detail in the method embodiment, and details are not described herein again.

FIG. 13 illustrates the sixth structural diagram of a data processing device consistent with the disclosed embodiments consistent with the disclosed embodiments. As shown in FIG. 13, the device includes a receiving unit 1301 and an acquisition unit 1302.

The receiving unit 1301 receives a data interrupt message sent by the data monitoring unit. The data interrupt message is a data interrupt message of the first data that meets the interrupt condition in the data to be interrupted monitored by the data monitoring unit.

The acquisition unit 1302 obtains, according to the data interrupt message, the data monitoring result of the first data is obtained from the monitoring result of the data to be interrupted acquired by the data monitoring unit.

In one embodiment, the device may be a BMC, which obtains the senor data of each component to be monitored according to the state information of each component to be monitored reported by a sensor.

In one embodiment, the device further includes: a parsing unit 1303, a search unit 1304, and an extraction unit 1305. Specifically, according to the data interrupt message, after obtaining the data monitoring result of the first data from the monitoring result of the data to be interrupted obtained by the data monitoring unit, the acquisition unit 1302 triggers the parsing unit 1303 to parse the data interrupt message to obtain parsed data for the data interrupt message; after obtaining the parsed data for the data interrupt message by parsing the data interrupt message, the parsing unit 1303 triggers the search unit 1304 to search for the data monitoring result of the first data in the parsed data; after finding the data monitoring result of the first data in the parsed data, the search unit 1304 triggers the extraction unit 1305 to extract the data monitoring result of the first data in the parsed data.

In one embodiment, the device further includes a sending unit 1306. Specifically, after the search unit 1304 does not find the data monitoring result of the first data in the parsed data, the sending unit 1306 is triggered to send the data acquisition request for the first data to the data monitoring unit; after the data acquisition request is determined to be successfully responded by the data monitoring unit, the receiving unit 1301 is triggered to receive the data monitoring result of the first data sent by the monitoring unit.

It should be noted that, when the data processing devices provided by the foregoing embodiment obtains the sensor data from the interrupt message reported by the sensor in the BMC, only the division of each of the foregoing program modules is illustrated. In practical applications, the foregoing processing may be allocated by different program modules as needed. That is, the internal structure of the data processing device is divided into different program modules to perform all or part of the processing described above. In addition, both the data processing devices provided by the foregoing embodiment and the foregoing data processing method embodiments belong to the same concept, and the specific implementation process is described in detail in the method embodiment, and details are not described herein again.

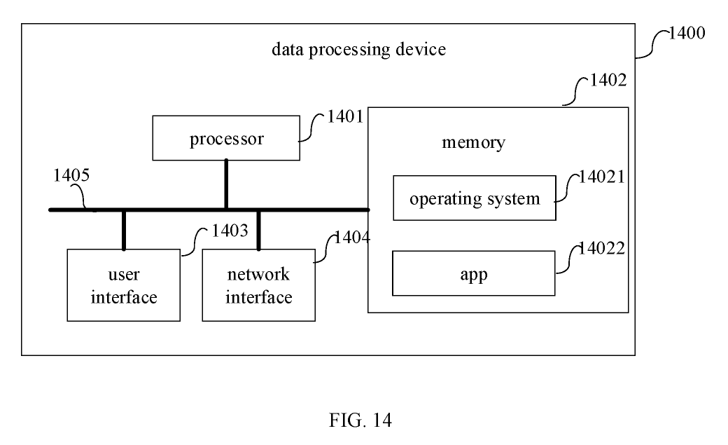

FIG. 14 illustrates the seventh structural diagram of a data processing device consistent with the disclosed embodiments. As shown in FIG. 14, the data processing device 1400 may be a mobile phone, a computer, a digital broadcast terminal, an information transceiver device, a game console, a tablet device, an individual digital assistant, an information push server, a content server, an identity authentication server, or the like. The data processing device 1400 shown in FIG. 14 includes at least one processor 1401, a memory 1402, at least one network interface 1404, and a user interface 1403. The various components in the data processing device 1400 are coupled together by a bus system 1405. The bus system 1405 implements connection communication between these components. The bus system 1405 includes a power bus, a control bus, and a status signal bus in addition to a data bus. However, for the sake of clarity, all various buses are labeled as bus system 1405 in FIG. 14.

The user interface 1403 may include a display, a keyboard, a mouse, a trackball, a click wheel, a button, a button, a touch panel, or a touch screen.

The memory 1402 can be either a volatile memory or a nonvolatile memory, and can include both a volatile memory and a nonvolatile memory. The non-volatile memory may be a Read Only Memory (ROM), a Programmable Read-Only Memory (PROM), or an Erasable Programmable Read-Only Memory (EPROM), an Electrically Erasable Programmable Read-Only Memory (EEPROM), a Ferromagnetic Random-Access Memory (FRAM), a Flash Memory, an Magnetic Surface Memory, a CD-ROM, or a CD-ROM (Compact Disc Read-Only Memory). The magnetic surface memory can be a disk storage or a tape storage. The volatile memory can be a random-access memory (RAM) that acts as an external cache. By the illustrative not limiting description, many forms of RAM are available, such as Static Random-Access Memory (SRAM), Synchronous Static Random-Access Memory (SSRAM), Dynamic Random-Access Memory (DRAM), Synchronous Dynamic Random-Access Memory (SDRAM), Double Data Rate Synchronous Dynamic Random-Access Memory (DDRSDRAM), Enhanced Synchronous Dynamic Random-Access Memory (ESDRAM), SyncLink Dynamic Random-Access Memory (SLDRAM), and Direct Rambus Random Access Memory (DRRAM). The memory 1102 described in one embodiment is intended to include, but not limited to, these and any other suitable types of memories.

In one embodiment, the memory 1402 stores various types of data to support the operations of the data processing device 1400. Examples of such data include any computer program for operations on data processing device 1100, such as the operating system 14021 and the app 14022. The operating system 14021 includes various system programs, such as a framework layer, a core library layer, a driver layer and the like for implementing various basic services and handling hardware-based tasks. The app 14022 can include various apps, such as Media Players, Browsers and the like for implementing various app services. The program implementing the method may be included in the app 14022.

The method disclosed in the foregoing embodiments may be applied to the processor 1401 or implemented by the processor 1401. The processor 1401 may be an integrated circuit chip with signal processing capabilities. In the implementation process, each step of the foregoing method may be completed by an integrated logic circuit of hardware in the processor 1401 or a command in the form of software. The processor 1401 described above may be a general-purpose processor, a digital signal processor (DSP), or other programmable logic device, discrete gate or transistor logic device, discrete hardware component, or the like. The processor 1401 can implement or perform various methods, steps, and logic blocks disclosed in one embodiment. The general-purpose processor can be a microprocessor or any conventional processor or the like. The steps of the method disclosed in one embodiment may be directly implemented as a hardware decoding processor, or may be performed by a combination of hardware and software modules in the decoding processor. The software module can be located in a storage medium. The storage medium is located in the memory 1402. The processor 1401 reads the information in the memory 1402, and completes the steps of the foregoing method in combination with the hardware thereof.

In one exemplary embodiment, the data processing device 1400 may be implemented by one or more Application Specific Integrated Circuits (ASICs), DSPs, Programmable Logic Devices (PLDs), Complex Programmable Logic Devices (CPLDs), Field-Programmable Gate Arrays (FPGAs), general-purpose processors, controllers, Micro Controller Units (MCUs), microprocessor, or other electronic component to perform the foregoing methods.

Specifically, when running the computer program, the processor 1101 performs: monitoring the interrupted data to obtain the monitoring result of the data to be interrupted; determining that the first data meets the interrupt condition in the data to be interrupted according to the monitoring result; and sending a data interrupt message for the first data to the BMC. The data interrupt message enables the BMC to acquire the data monitoring result of the first data from the monitoring result of the data to be interrupted;

In one embodiment, the data interrupt message for the first data is sent to the BMC, so that after chips supporting the first function of the two or more chips included in the BMC receive the data interrupt message, the data monitoring result of the first data is obtained from the monitoring result of the data to be interrupted. The first function includes a function of obtaining the data monitoring result of the first data from the monitoring result of the data to be interrupted.

When running the computer program, the processor 1401 further performs: sending a data interruption message for the first data to the BMC. The data interruption message carries a data monitoring result for the first data. The data interrupt message enables the BMC to obtain the data monitoring result of the first data from the data interrupt message

When running the computer program, the processor 1401 further performs: receiving a data acquisition request sent by the BMC for the first data; searching for the data monitoring result of the first data in the monitoring result of the data to be interrupted according to the data acquisition request; and sending the found data monitoring result of the first data to the BMC.

In one embodiment, when running the computer program, the processor 1401 further performs: receiving a data interrupt message sent by the data monitoring unit, wherein the data interrupt message is a data interrupt message of the first data that meets the interrupt in the data to be interrupted by the data monitoring unit; obtaining the data monitoring result of the first data from the monitoring result of the data to be interrupted obtained by the data monitoring unit according to the data interrupt message; when running computer programs, the processor 1401 further performs: parsing the data interrupt message to obtain the parsed data for the data interrupt message; extracting data monitoring results of the first data from the parsed data; when running the computer program, the processor 1401 further performs: sending a data acquisition request for the first data to the data monitoring unit; and receiving the data monitoring result of the first data sent by the monitoring unit after the data acquisition request is determined to be successfully responded by the data monitoring unit.

One exemplary embodiment provides a computer readable storage medium, such as the memory 1402 including computer programs. The computer programs can be executed by the processor 1401 of the data processing device 1400 to perform the steps in the foregoing method. The computer readable storage medium may be a memory such as FRAM, ROM, PROM, EPROM, EEPROM, Flash Memory, magnetic surface memory, optical disk, or CD-ROM. The medium may also be various devices including one or any combination of the above memories, such as mobile phones, computers, tablet devices, personal digital assistants, and the like.

A computer readable storage medium stores computer programs. When running computer programs, the processor performs: monitoring the interrupt data to obtain the monitoring result of the data to be interrupted; determining the first data that meets the interrupt condition in the data to be interrupted according to the monitoring result; and sending a data interrupt message for the first data to the BMC, wherein the data interrupt message enables the BMC to acquire data monitoring result of the first data from the monitoring result of the data to be interrupted.

When running computer programs, the processor further performs: sending a data interrupt message for the first data to the BMC. The data interrupt message carries a data monitoring result for the first data. The data interrupt message enables the BMC to acquire the monitoring result of the first data from the data interrupt message.

When running computer programs, the processor further performs: receiving a data acquisition request sent by the BMC for the first data; searching for the data monitoring result of the first data in the monitoring result of the data to be interrupted according to the data acquisition request; and sending the found data monitoring result of the first data to the BMC.

In one embodiment, when running computer programs, the processor 1401 further performs: receiving a data interrupt message sent by a data monitoring unit, wherein the data interrupt message is a data interrupt message of the first data that meets the interrupt in the data to be interrupted monitored by the data monitoring unit; and obtaining the data monitoring result of the first data from the monitoring result of the data to be interrupted obtained by the data monitoring unit according to the data interrupt message.

When running computer programs, the processor 1401 further performs: parsing the data interrupt message to obtain the parsed data for the data interrupt message; and extracting data monitoring results of the first data from the parsed data.

When running computer programs, the processor 1401 further performs: sending a data acquisition request for the first data to the data monitoring unit; and receiving the data monitoring result of the first data sent by the monitoring unit after the data acquisition request is determined to be successfully responded by the data monitoring unit.

The above descriptions are only the specific embodiments of the present disclosure. The scope of the present disclosure is not limited thereto. Those skilled in the art can easily think of changes or substitutions within the technical scope of the present disclosure. The changes and substitutions should be covered within the protection scope of the present disclosure. The protection scope of the present disclosure shall be subject to the protection scope of the claims.

What is claimed is:

1. A data processing method for a baseboard management controller (BMC) including two or more chips, the method comprising:
obtaining a first command;
based on the first command, determining a first function corresponding to the first command;
searching for at least one first chip supporting the first function in the two or more chips; and
sending the first command to the at least one first chip supporting the first function, such that the at least one first chip executes the first command to implement the first function.

2. The method according to claim 1, further comprising:
after it is determined that a second function needs to be implemented before the first function is implemented, searching for at least one second chip supporting the second function in the two or more chips; and
sending a second command to the at least one second chip supporting the second function, such that the at least one second chip executes the second command to implement the second function.

3. The method according to claim 1, further comprising:
controlling the two or more chips to send a heartbeat message to each other within a preset period; and
determining that the BMC is faulty after it is determined that at least one of the two or more chips does not to receive the heartbeat message within the preset period.

4. The method according to claim 2, further comprising,
generating a third command after a second operation is detected;
parsing the third command to obtain program version information carried in the third command after the third command is determined to be a program update command;
determining a chip to be updated in the two or more chips according to the program version information; and
sending the third command to the chip to be updated, such that the chip to be updated execute the third command to complete a program update operation.

5. The method according to claim 4, wherein:
after the third command is sent to the chip to be updated to enable the chip to be updated to execute the third command to complete the program update operation, the method further includes:
controlling other chips in the two or more chips except the chip to be updated to maintain a current operational state after the other chips are determined to be in a task execution state.

6. The method according to claim 1, wherein obtaining the first command includes:
generating the first command after a first operation is detected.

7. The method according to claim 1, wherein obtaining the first command includes:
receiving a data interrupt message sent by a data monitoring unit, wherein the data interrupt message is of a first data that meets an interrupt condition in data to be interrupted monitored by the data monitoring unit, wherein the first command includes the data interrupt message;
determining a first function corresponding to the first command according to the first command; and
determining a function corresponding to the data interrupt message, wherein the function indicates the BMC to acquire a data monitoring result of the first data from monitoring results of the data to be interrupted.

8. The data processing method according to claim 7, wherein sending the first command to the at least one first chip supporting the first function, such that the at least one first chip executes the first command to implement the first function includes:
sending the data interrupt message to the at least one first chip supporting the first function, such that the at least one first chip parses the data interrupt message, obtains parsed data for the interrupt message, and extracts the data monitoring result of the first data in the parsed data.

9. The data processing method according to claim 7, wherein sending the first command is sent to the at least one first chip supporting the first function, such that the at least one first chip executes the first command to implement the first function includes:
sending the data interrupt message to the at least one first chip supporting the first function, such that the at least one first chip sends a data acquisition request for the first data to the data monitoring unit; and
receiving the data monitoring result of the first data sent by the monitoring unit after the data acquisition request is determined to be successfully responded by the data monitoring unit.

10. A data processing method, comprising:
monitoring data to be interrupted to obtain monitoring results of the data to be interrupted;
determining a first data that meets an interrupt condition in the data to be interrupted according to the monitoring results; and
sending a data interrupt message for the first data to the BMC, such that a chip supporting the first function of two or more chips included in the BMC acquires a data monitoring result of the first data from the monitoring results of the data to be interrupted after the data interrupt message is received,
wherein the first function includes a function of obtaining the data monitoring result of the first data from the monitoring results of the data to be interrupted.

11. A baseboard management controller (BMC) system, comprising:
an acquisition unit for obtaining a first command;
a determination unit for, based on the first command, determining a first function corresponding to the first command;
a search unit for searching for at least one first chip supporting the first function in two or more chips in the BMC system; and
a sending unit for sending the first command to the at least one first chip supporting the first function, such that the at least one first chip executes the first command to implement the first function.

12. The system according to claim 11, wherein:
the searching unit, after it is determined that a second function needs to be implemented before the first function is implemented, searches for at least one second chip supporting the second function in the two or more chips; and
the sending unit sends a second command to the at least one second chip supporting the second function, such that the at least one second chip executes the second command to implement the second function.

13. The system according to claim 11, further comprising:
a control unit for controlling the two or more chips to send a heartbeat message to each other within a preset period, wherein:
the determination unit for determining that the BMC is faulty after it is determined that at least one of the two or more chips does not to receive the heartbeat message within the preset period.

14. The system according to claim 12, wherein the acquisition unit generates a third command after a second operation is detected, and the system further comprises:
a parsing unit for parsing the third command to obtain program version information carried in the third command after the third command is determined to be a program update command, wherein:
the determination unit determines a chip to be updated in the two or more chips according to the program version information; and
the sending unit sends the third command to the chip to be updated, such that the chip to be updated execute the third command to complete a program update operation.

15. The system according to claim 14, further comprising:
a control unit for controlling other chips in the two or more chips except the chip to be updated to maintain a current operational state after the other chips are determined to be in a task execution state after the third command is sent to the chip to be updated to enable the chip to be updated to execute the third command to complete the program update operation.

16. The system according to claim 11, further comprising:
a generating unit for generating a first command after a first operation is detected.

17. The system according to claim 11, wherein:
the acquisition unit further includes a receiving unit for receiving a data interrupt message sent by a data monitoring unit, wherein the data interrupt message is of a first data that meets an interrupt condition in data to be interrupted monitored by the data monitoring unit, wherein the first command includes the data interrupt message;
the determination unit determines a first function corresponding to the first command according to the first command and determines a function corresponding to the data interrupt message, wherein the function indicates the BMC to acquire a data monitoring result of the first data from monitoring results of the data to be interrupted.

18. The system according to claim 17, wherein:
the sending unit sends the data interrupt message to the at least one first chip supporting the first function, such that the at least one first chip parses the data interrupt message, obtains parsed data for the interrupt message, and extracts the data monitoring result of the first data in the parsed data.

19. The system according to claim 17, wherein:
the sending unit sends the data interrupt message to the at least one first chip supporting the first function, such that the at least one first chip parses the data interrupt message, obtains parsed data for the interrupt message, and extracts the data monitoring result of the first data in the parsed data.
the receiving unit receives the data monitoring result of the first data sent by the monitoring unit after the data acquisition request is determined to be successfully responded by the data monitoring unit.
